(19) United States
(12) Patent Application Publication
(10) Pub. No.: US 2007/0109203 A1
(43) Pub. Date: May 17, 2007

(54) RESONANT FREQUENCY TUNABLE ANTENNA APPARATUS

(75) Inventors: Il Hwan Park, KYUNGKI-DO (KR); Hyun Hak Kim, KYUNGKI-DO (KR); Yong Bum Lee, KYUNGKI-DO (KR); Jong Lae Kim, KYUNGKI-DO (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., KYUNGKI-DO (KR)

(21) Appl. No.: 11/462,622

(22) Filed: Aug. 4, 2006

(30) Foreign Application Priority Data
Aug. 5, 2005 (KR) 10-2005-0071583

(51) Int. Cl. H01Q 1/24

(52) U.S. Cl. 343/702; 343/700 MS; 343/895

(57) ABSTRACT

In a tunable antenna apparatus, a dielectric block is mounted on a printed circuit board. A radiation pattern has a feeding part formed on the dielectric block and connected commonly to a feeding source and a variable DC power. Also, a connecting pattern extends from the radiation pattern onto the printed circuit board. In addition, at least one tuning pattern is formed on the printed circuit board and connected in series to the connecting pattern via at least one switching device.

### CLAIM OF PRIORITY

This application claims the benefit of Korean Patent Application No. 2005-71583 filed on Aug. 5, 2005, in the Korean Intellectual Property Office, the disclosure of which is incorporated herein by reference.

### BACKGROUND OF THE INVENTION

1. Field of the Invention

The present invention relates to an antenna, and more particularly to an antenna apparatus which adjusts an electrical resonant length in a wide frequency bandwidth via a switching device to vary a resonant frequency into a desired available frequency band.

2. Description of the Related Art

With recent advancement in a mobile multimedia broadcasting technology, there has arisen a need to develop terrestrial broadcasting antennas and satellite broadcasting antennas suitable for a mobile telecommunication terminal.

But, in general, broadcasting antennas are low in frequency and wide in frequency bandwidth compared to wireless LANs or short-range wireless telecommunications. For example, DVB-H, the European portable broadcasting standard requires an antenna to be operable at a wide bandwidth of 475 to 702 MHz, thus adopting a large external antenna.

Furthermore, conventionally, to selectively transmit/receive a specified bandwidth for desired broadcasting, a resonant length of the antenna was adjusted via switching. But such a conventional switching method requires separate signal lines for switching on/off to be disposed in a narrow antenna space, which accordingly is a difficult process. In addition, the signal lines for switching on/off cause interruption and noises in the antenna.

Therefore in the art, there has been a demand for a smaller antenna apparatus which can adjust a resonant frequency by a switching device at a wide bandwidth and alleviate interference or noises resulting from the switching device.

### SUMMARY OF THE INVENTION

The present invention has been made to solve the foregoing problems of the prior art and therefore an object according to certain embodiments of the present invention is to provide a resonant frequency tunable antenna apparatus which turns on/off a switching device in response to a DC voltage applied to a radiation pattern to simplify a signal line, and is designed in an adequate arrangement to enhance antenna properties.

According to an aspect of the invention for realizing the object, there is provided a resonant frequency tunable antenna apparatus comprising: a radiation pattern having a feeding part connected to a feeding source and a variable DC power; and at least one tuning pattern connected in series to the connecting pattern via at least one switching device, wherein the switching device is turned on/off in response to a voltage applied from the variable DC power, and wherein a resonant frequency is lowered in accordance with a length of the tuning pattern which is added by turn-on of the switching device.

According to another aspect of the invention for realizing the object, there is provided a resonant frequency tunable antenna apparatus comprising: a dielectric block; a part of a printed circuit board where the dielectric block is mounted; a radiation pattern having a feeding part formed on the dielectric block and connected commonly to a feeding source and a variable DC power; a connecting pattern extending from the radiation pattern onto the printed circuit board; and at least one tuning pattern formed on the printed circuit board, the tuning pattern connected in series to the connecting pattern via at least one switching device.

In this fashion, the main radiation pattern is disposed on the dielectric block, thereby maintaining superior antenna properties. Also, the switching device and related patterns are formed on the printed circuit board, thereby simplifying further the switching circuit.

Preferably, to select a variety of resonant frequencies, the resonant frequency tunable antenna apparatus comprises a plurality of the switching device and a plurality of the tuning pattern, wherein the switching devices are disposed such that the tuning patterns are connected in series to one another.

Preferably, a ground part is provided to the printed circuit board, wherein the switching device is disposed on the printed circuit board between the dielectric block and the ground part.

The tuning pattern employed in the invention may be partially or entirely disposed on the printed circuit board according to an embodiment of the invention.

According to an embodiment of the invention, the tuning pattern comprises first and second patterns, the first pattern formed on the printed circuit board and connected to the switching board, and the second pattern formed on an underside surface of the dielectric block and electrically connected to the first pattern, wherein the two conductive patterns are integrally connected to each other.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a basic conceptual view illustrating an antenna apparatus according to the invention;

FIG. 2 is a perspective view illustrating an antenna apparatus according to an embodiment of the invention;

FIG. 3 is a perspective view illustrating an antenna apparatus according to another embodiment of the invention;

FIG. 4a is a perspective view illustrating a chip antenna according to further another embodiment of the invention;

FIG. 4b is a perspective view illustrating an antenna apparatus in which the chip antenna of FIG. 4a is employed;

FIGS. 5a to 5d are graphs illustrating a resonant frequency change in accordance with a voltage applied in the antenna apparatus according to an embodiment of the invention, respectively; and

FIGS. 6a to 6d are graphs illustrating a resonant frequency change in accordance with a voltage applied in the antenna apparatus according to another embodiment of the invention, respectively.

### DETAILED DESCRIPTION OF THE PREFERRED EMBODIMENT

Preferred embodiments of the present invention will now be described in detail with reference to the accompanying drawings.

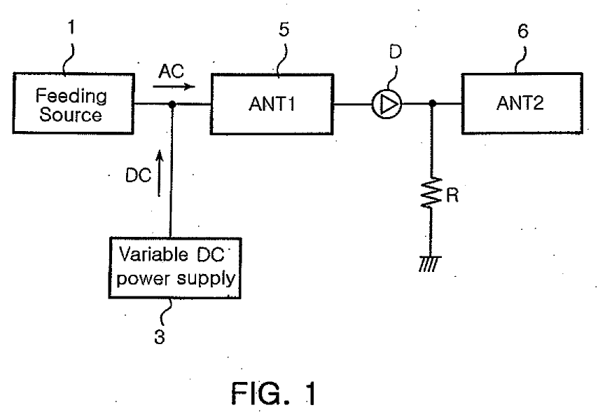

FIG. 1 is a basic conceptual view illustrating an antenna apparatus according to the invention.

Referring to FIG. 1, the antenna apparatus of the invention includes at least two antennas ANT1 and ANT2. The first antenna ANT1, as a radiation component, has an electrical resonant length corresponding to a first resonant frequency. Meanwhile, the second antenna ANT2, as a tuning radiation component, is combined with the first antenna ANT1 to provide a second resonant frequency, lower than the first resonant frequency. The first and second antennas 5 and 6 are connected with each other by a diode D, which is a switching device.

According to the invention, the diode is not connected to a separate driving signal line. However, the first antenna 5 is connected to a feeding source and a variable driving power supply 3, thereby receiving both an AC signal from the feeding source 1 and a DC signal for a driving voltage. That is, a switching of the invention is structured such that the first antenna 5 is provided with an AC voltage for feeding the first antenna 5 and a DC voltage for driving the diode D through an identical signal line. The variable driving power supply may be configured as a Pulse Wave Modulator, and a desired available frequency is adjustable by turning on/off the diode D in response to a driving voltage.

In this fashion, according to the invention, a desired available frequency can be adjusted through a simple switching circuit structure. Especially, the invention does not require a separate signal line for driving the switching device, thereby preventing interference and noises arising therefrom.

The invention provides a method for adequately arranging the chief component of the antenna, i.e., a radiation pattern and a tuning pattern for changing an available frequency in order to improve antenna properties and make the switching circuit easily arranged in actual fabrication of the antenna apparatus.

According to the invention, the radiation pattern is structured as a chip antenna using a dielectric block to attenuate insertion loss of the antenna. Also, the tuning pattern is disposed on the printed circuit board having the chip antenna mounted thereon or formed integrally with the chip antenna pattern. Preferably, the switching device is disposed on the printed circuit board to fabricate the antenna more easily.

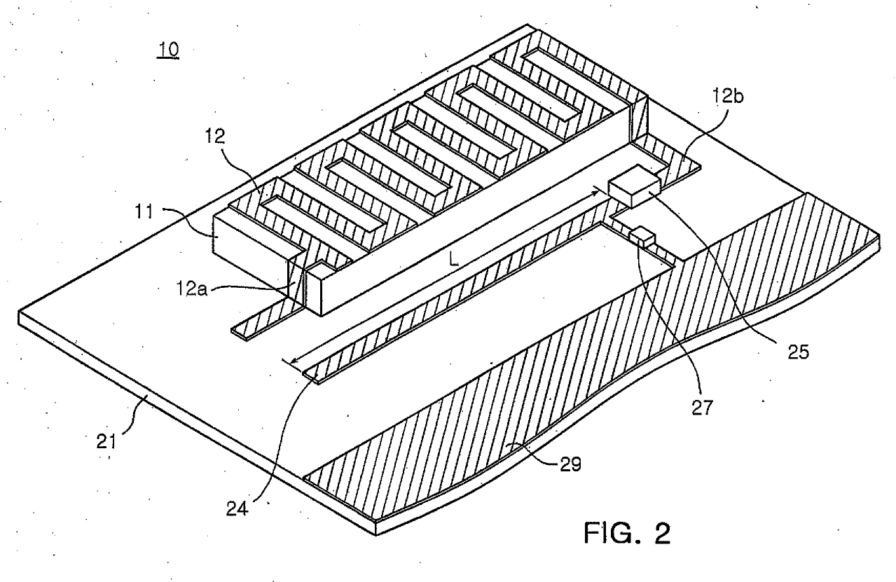

FIG. 2 is a perspective view illustrating an antenna apparatus 10 according to an embodiment of the invention. This embodiment employs a tuning pattern 24 and a switching device 25.

The antenna apparatus according to this embodiment basically includes a radiation pattern 12 disposed on a dielectric block 11, and a tuning pattern 24 and a switching device 25 each disposed on a printed circuit board 21 where the dielectric block 11 is mounted.

The radiation pattern 12 is formed of a conductive pattern on the dielectric block 11, thereby ensuring superior radiation properties in a main radiation part of the antenna. Also, the tuning pattern 24 is formed of a conductive pattern on the printed circuit board 21. The tuning pattern 24 formed on the printed circuit board allows the switching device 25 to be easily mounted on the printed circuit board.

The radiation pattern 12 includes a feeding part 12a and a connecting pattern 12b. The feeding part 12a is connected to a feeding source (not illustrated) for providing transmission/reception signals and a variable DC power supply (not illustrated) for adjusting on/off of the switching device 25. The connecting pattern 12b is formed on the printed circuit board 21, extending toward the tuning pattern 24. The switching device 25 is connected between the connecting pattern 12b and the tuning pattern 24.

The tuning pattern 24 connected to the switching device 25 is connected to a resistance device 27 connected to a ground plate 29, ensuring a voltage difference for a switching operation. To connect easily as just described, as in this embodiment, preferably, the tuning pattern 24 and switching device 25 are disposed between the dielectric block 11 of the printed circuit board 21 and the ground plate 29. In a case where the switching device 25 is turned off, an electrical resonant length of the antenna 10 is determined by a radiation pattern 12 (including a connecting pattern 12(b)) and a first resonant frequency is determined correspondingly.

But with a predetermined level of a voltage applied from the variable DC power supply (not illustrated), the switching device 25 is turned on, and thus an electrical resonant length L corresponding to the tuning pattern is added. As a result, the resonant frequency of the antenna apparatus 10 is adjusted to a second resonant frequency which is lower than the first resonant frequency.

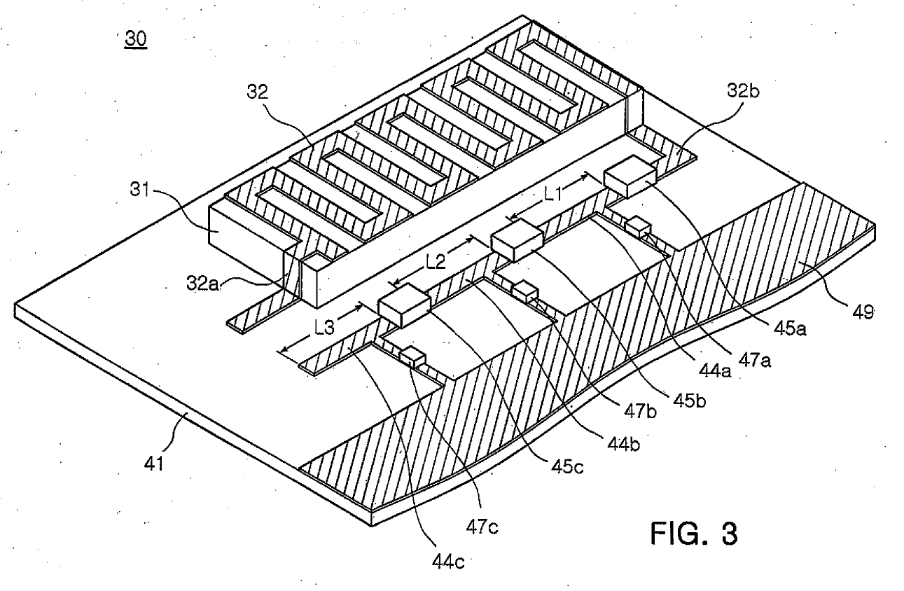

FIG. 3 is a perspective view illustrating an antenna apparatus 30 according to another embodiment of the invention. This embodiment employs three tuning patterns 44a, 44b and 44c and three switching devices 45a, 45b and 45c.

The antenna apparatus 30 of this embodiment basically includes a radiation pattern 32 disposed on a dielectric block 31, and the three tuning patterns 44a, 44b and 44c and the three switching devices 45a, 45b and 45c disposed on the printed circuit board 41 where the dielectric block 31 is mounted.

In the similar manner to FIG. 2, the radiation pattern 32 is formed of a conductive pattern on the dielectric block 31. The first to third tuning patterns 44a, 44b to 44c are connected in series to one another by the second and third switching devices 45b and 45c. Of course, the first tuning pattern 44a is connected to the connecting pattern 32b extending from the radiation pattern 32 and the first switching device 45a. Here, the first to third tuning patterns 44a, 44b and 44c are connected to resistance devices 47a, 47b and 47c grounded on the ground pate 49 to turn on/off the switching devices 45a, 45b and 45c.

A feeding part 32a of the radiation pattern 32 is connected to a feeding source (not illustrated) for applying transmission/reception signals and a variable DC power supply (not illustrated) for adjusting on/off of the switching devices. The first to third switching devices 44a, 44b and 44c may be turned on sequentially with increase in a voltage applied from the variable DC power supply. Consequently, the resonant frequency decided by the radiation pattern 32 is gradually adjusted to a lower resonant frequency. Also, resonant frequencies determined correspondingly to resonant lengths can be used selectively depending on a voltage applied. For example, a voltage is selected by which the first and second switching devices 45a and 45b are turned on and the third switching device 45c is turned off, thereby allowing selection of a resonant frequency corresponding to a combined resonant length of the first and second tuning patterns 44a and 44b.

In this fashion, with the three switching devices 45a, 45b and 45c turned on/off sequentially according to a voltage applied, the three tuning patterns 44a, 44b and 44c are added, thereby producing four resonant frequency ranges. The antenna apparatus 30 shown in FIG. 3 can be used as an antenna having four available frequencies depending on the voltage applied.

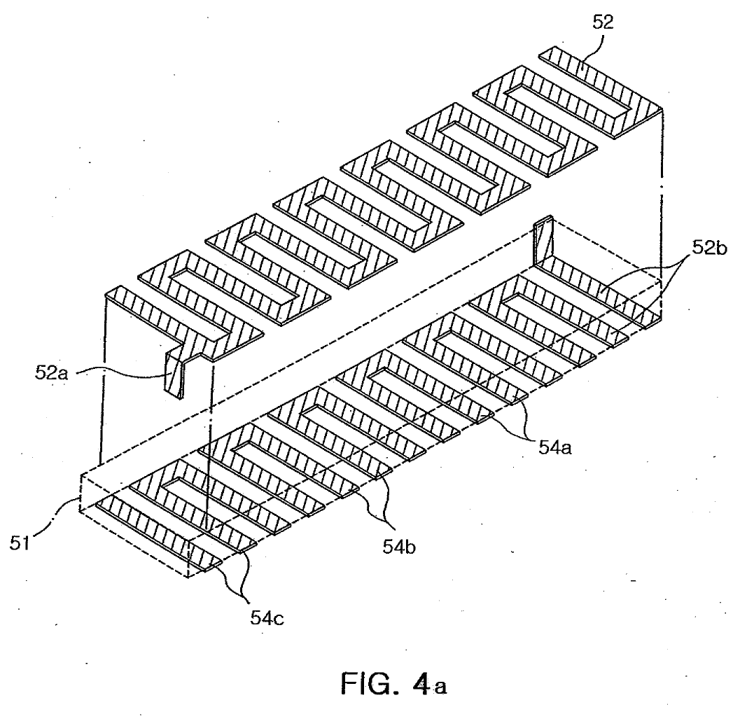

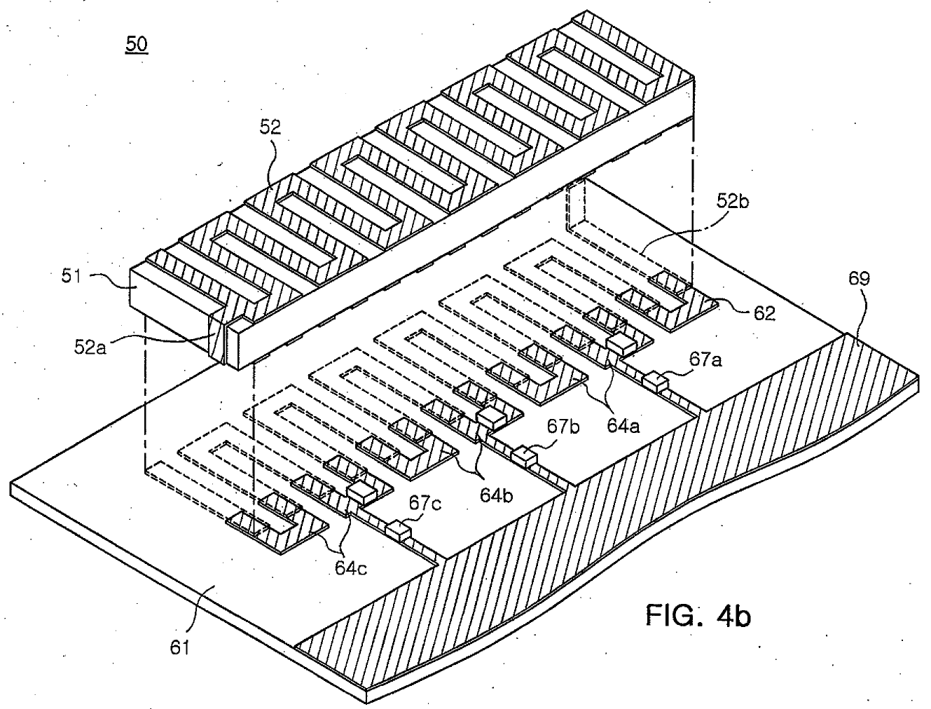

In the aforesaid embodiment, the tuning patterns are disposed on the printed circuit board, which accordingly allows the switching device to be mounted on the printed circuit board. The switching device, if disposed on the printed circuit board, is more advantageous for designing and fabrication of the antenna apparatus. Therefore, only a portion of the tuning patterns connecting to the switching device may be disposed on the printed circuit board and the other portion of the tuning patterns may be disposed on the dielectric block, especially on an underside surface thereof to be integrally connected with each other. FIG. 4a is an exploded perspective view illustrating a chip antenna according to this embodiment of the invention.

Referring to FIG. 4a, the chip antenna has a radiation pattern 52 formed on a dielectric block 51. The radiation pattern 52 has a feeding part 52a formed on an end, and two connecting patterns 52b formed on the other end. The connecting patterns 52b extend from the radiation pattern 52 onto an underside surface of the dielectric block 51.

Moreover, the dielectric block 51 has first to third conductive lines 54a, 54b and 54c formed on the underside surface of the dielectric block 51 to constitute portions of the first to third tuning patterns. The first to third conductive lines each have two separate patterns, which however may be designed to different sizes and shapes according to an adjustment range of a desired resonant frequency.

The chip antenna shown in FIG. 4a is mounted on a printed circuit board 61 where other conductive lines are formed as in FIG. 4b. The conductive lines 52b, 54a, 54b and 54c on the underside surface of the dielectric block 51 shown in FIG. 4a are apparently arranged as indicated with dotted lines in FIG. 4b. That is, the connecting pattern 52b is connected to a connecting pattern 62 of the printed circuit board to integrally form a connecting pattern.

The first to third conductive lines 54a, 54b and 54c formed on the underside surface of the dielectric block 51 are connected to the first to third conductive patterns 64a, 64b and 64c formed on the printed circuit board, respectively, thereby constituting first to third tuning patterns, respectively. A first switching device 65a is disposed between the connecting patterns and the first tuning pattern. Likewise, a second switching device 65b is disposed between the connecting patterns and the second tuning pattern, and also a third switching device 65c is disposed between the connecting patterns and the third tuning pattern. In addition, the respective first to third tuning patterns 54a, 54b and 54c; 64a, 64b and 65c are connected to respective resistance devices 67a, 67b and 67c grounded on a ground plate 69 to turn on/off switching devices 65a, 65b and 65c.

In this structure, with the switching devices 65a, 65b and 65c turned on/off sequentially, the tuning patterns 54a, 54b and 54c; 64a, 64b and 65c are added, thereby producing four resonant frequency ranges. Accordingly, the four resonant frequencies can be selected as an available frequency depending on a voltage applied.

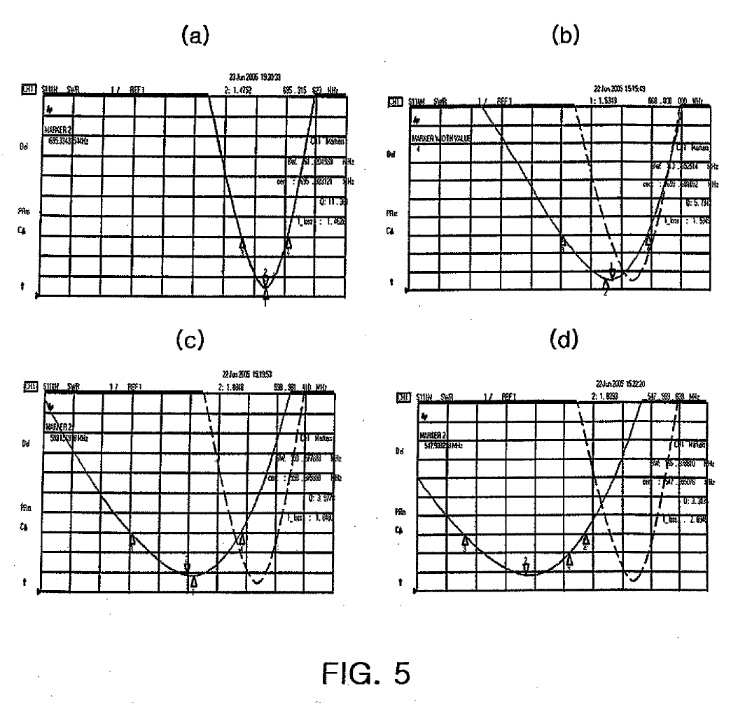

FIGS. 5a to 5d are graphs illustrating a resonant frequency change in response to a voltage applied in an antenna apparatus according to an embodiment of the invention.

The graphs plot changes in the resonant frequency in response to the voltage applied using the antenna apparatus of the invention. The antenna apparatus used in the measurement employs three tuning patterns and three switching devices as shown in FIG. 3. Each of the switching devices is a Positive Intrinsic Negative (PIN) diode for switching on at a voltage of 0.7V, and the radiation pattern and tuning patterns are designed to have a resonant frequency ranging from about 475 to 702 MHz.

When no voltage is applied, a resonant frequency is decided by a radiation pattern of the dielectric block with all switching devices turned off. At this time, as shown in FIG. 5a, the resonant frequency is measured at 695 MHZ. When a voltage of 0.7 is applied, as shown in FIG. 5b, a first tuning pattern is connected to the radiation pattern and the resonant frequency is moderately lowered to 659 MHZ.

When a voltage of 1.4V is applied, the first to second tuning patterns are connected to the radiation pattern, and the resonant frequency is further lowered to 598 MHZ. Also, with a voltage of 2.1V applied, all switching devices are turned on and a resonant length is prolonged to the third tuning pattern. Thus the resonant frequency is reduced to 547 MHZ.

In this fashion, the resonant length can be properly adjusted by sequential switching-on in order to select a desired resonant frequency.

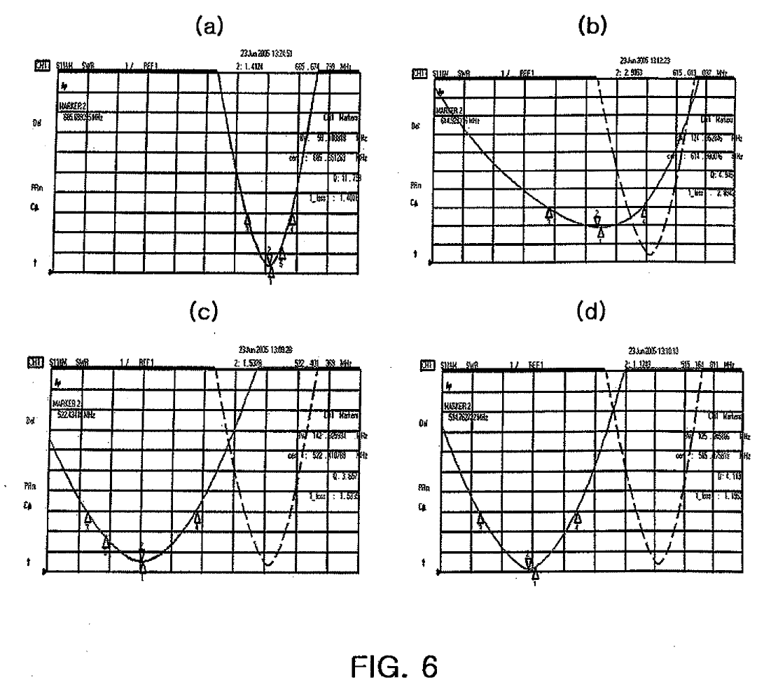

FIGS. 6a to 6d are graphs illustrating changes in a resonant frequency in accordance with a voltage applied in an antenna apparatus according to further another embodiment of the invention.

The graphs illustrate a measurement result for the antenna apparatus designed similarly to FIG. 2. That is, as shown in FIG. 2, a tuning pattern is designed to be connected to a radiation pattern via a switching device. The switching device employed is a PIN diode which is turned on at a voltage of about 0.7V.

As in FIG. 6a, when no voltage is applied, a resonant frequency is 685 MHZ. But when the tuning pattern is integrally connected to the radiation pattern with the switching device turned on, the resonant frequency is lowered to 614 MHZ as in FIG. 6b (0.7V). This change in FIG. 6b apparently results from increase in the resonant length by turn-on of the switching device.

Further, as shown in FIGS. 6c and 6d, when a voltage is raised to 1.4V and 2.1V even with the switching device turned on, the resonant frequency is confirmed to be lowered to 522 MHZ and 515 MHZ, respectively. This is not ascribed to a change in the resonant length by the turn-on the switching device as shown in FIG. 6b. But this is apparently because current flows in different amounts between the radiation pattern and the tuning patterns, thereby affecting impedance. Consequently, the resonant frequency can be changed by additional increase in the voltage applied even with the switching device turned on.

As set forth above, according to certain embodiments of the invention, a resonant frequency tunable antenna apparatus turns on/off a switching device via a DC voltage inputted to a radiation pattern, thereby simplifying a signal line structure. Also, according to the invention, a main radiation pattern and switching devices can be arranged in adequate proportions on a dielectric circuit board and a printed circuit board, thereby enhancing antenna properties.

While the present invention has been shown and described in connection with the preferred embodiments, it will be apparent to those skilled in the art that modifications and variations can be made without departing from the spirit and scope of the invention as defined by the appended claims.

What is claimed is:

1. A resonant frequency tunable antenna apparatus comprising:
a dielectric block;
a part of a printed circuit board where the dielectric block is mounted;
a radiation pattern having a feeding part formed on the dielectric block and connected commonly to a feeding source and a variable DC power;
a connecting pattern extending from the radiation pattern onto the printed circuit board; and
at least one tuning pattern formed on the printed circuit board, the tuning pattern connected in series to the connecting pattern via at least one switching device.

2. The resonant frequency tunable antenna apparatus according to claim 1, comprising a plurality of the switching device and a plurality of the tuning pattern, and
wherein the switching devices are disposed such that the tuning patterns are connected in series to one another.

3. The resonant frequency tunable antenna apparatus according to claim 1, wherein a ground part is provided to the printed circuit board, and
wherein the switching device is disposed on the printed circuit board between the dielectric block and the ground part.

4. The resonant frequency tunable antenna apparatus according to claim 1, wherein the tuning pattern comprises a conductive pattern formed on the printed circuit board.

5. The resonant frequency tunable antenna apparatus according to claim 1, wherein the tuning pattern comprises first and second patterns, the first pattern formed on the printed circuit board and connected to the switching board, and the second pattern formed on an underside surface of the dielectric block and electrically connected to the first pattern,
wherein the two conductive patterns are integrally connected to each other.

6. A resonant frequency tunable antenna apparatus comprising:
a radiation pattern having a feeding part connected to a feeding source and a variable DC power; and
at least one tuning pattern connected in series to the connecting pattern via at least one switching device,
wherein the switching device is turned on/off in response to a voltage applied from the variable DC power, and
wherein a resonant frequency is lowered in accordance with a length of the tuning pattern which is added by turn-on of the switching device.
